(19) United States
(12) Patent Application Publication
(10) Pub. No.: US 2025/0256578 A1
(43) Pub. Date: Aug. 14, 2025

(54) CONTROL DISPLAY METHOD AND APPARATUS, ELECTRONIC DEVICE, AND READABLE STORAGE MEDIUM

(71) Applicant: VIVO MOBILE COMMUNICATION CO., LTD., Dongguan (CN)

(72) Inventor: Shaoling LIU, Dongguan (CN)

(73) Assignee: VIVO MOBILE COMMUNICATION CO., LTD., Dongguan (CN)

(21) Appl. No.: 19/194,226

(22) Filed: Apr. 30, 2025

Related U.S. Application Data
(63) Continuation of application No. PCT/CN2023/127045, filed on Oct. 27, 2023.

(30) Foreign Application Priority Data
Nov. 9, 2022 (CN) 202211395557.0

(51) Int. Cl. B60K 35/81; B60K 35/10; B60K 35/22

(52) U.S. Cl. CPC B60K 35/81; B60K 35/10; B60K 35/22; B60K 2360/119; B60K 2360/577

(57) ABSTRACT

A control display method, an electronic device, and a readable storage medium are provided. The control display method, performed by an in-vehicle electronic device, includes: receiving a first input from a user when a target interface is displayed on a display screen of the in-vehicle electronic device, where the target interface is a projection interface of a mobile electronic device on the display screen, and the first input is used to adjust a focus position; and moving the focus position to a target control in response to the first input, and displaying the target control in a target display manner, where the target control is a control in the target interface, the target display manner is consistent with a display manner of a focus state control in a first interface of the in-vehicle electronic device, and the first interface is a native interface of the in-vehicle electronic device.

### CROSS-REFERENCE TO RELATED APPLICATIONS

This application is a continuation of International Application No. PCT/CN2023/127045, filed Oct. 27, 2023, which claims priority to Chinese Patent Application No. 202211395557.0, filed Nov. 9, 2022. The entire contents of each of the above-referenced applications are expressly incorporated herein by reference.

### TECHNICAL FIELD

This application belongs to the field of terminal technologies, and specifically, to a control display method and apparatus, an electronic device, and a readable storage medium.

### BACKGROUND

In a related technology, when interface content of a mobile electronic device is displayed through screen projection to an in-vehicle electronic device, a focus state display style of a control button in an application interface of the in-vehicle electronic device itself is relatively different from a focus state display style of a control button in a projection interface. In this way, a display style of display content on a display screen of the in-vehicle electronic device is inconsistent, and a screen projection effect is relatively abrupt, thereby reducing uniformity and aesthetic of the display content of the in-vehicle electronic device.

### SUMMARY

An objective of embodiments of this application is to provide a control display method and apparatus, an electronic device, and a readable storage medium, so as to ensure uniformity and aesthetic of display content of an in-vehicle electronic device, thereby ensuring naturalness of a screen projection effect.

According to a first aspect, an embodiment of this application provides a control display method. The method is performed by an in-vehicle electronic device, and the control display method includes: receiving a first input from a user in a case that a target interface is displayed on a display screen of the in-vehicle electronic device, where the target interface is a projection interface of a mobile electronic device on the display screen, and the first input is used to adjust a focus position; and moving the focus position to a target control in response to the first input, and displaying the target control in a target display manner, where the target control is a control in the target interface, the target display manner is consistent with a display manner of a focus state control in a first interface of the in-vehicle electronic device, and the first interface is a native interface of the in-vehicle electronic device.

According to a second aspect, an embodiment of this application provides a control display apparatus. The apparatus is applied to an in-vehicle electronic device, and the control display apparatus includes: a receiving unit, configured to: receive a first input from a user in a case that a target interface is displayed on a display screen of the in-vehicle electronic device, where the target interface is a projection interface of a mobile electronic device on the display screen, and the first input is used to adjust a focus position; a processing unit, configured to: move the focus position to a target control in response to the first input; and a display unit, configured to display the target control in a target display manner, where the target control is a control in the target interface, the target display manner is consistent with a display manner of a focus state control in a first interface of the in-vehicle electronic device, and the first interface is a native interface of the in-vehicle electronic device.

According to a third aspect, an embodiment of this application provides an electronic device, where the electronic device includes a processor and a memory, the memory stores a program or instructions capable of running on the processor, and the program or the instructions are executed by the processor to implement the steps of the control display method in the first aspect.

According to a fourth aspect, an embodiment of this application provides a readable storage medium, where the readable storage medium stores a program or instructions, and the program or the instructions are executed by a processor to implement the steps of the control display method in the first aspect.

According to a fifth aspect, an embodiment of this application provides a chip, where the chip includes a processor and a communication interface, the communication interface is coupled to the processor, and the processor is configured to run a program or instructions to implement the steps of the control display method in the first aspect.

According to a sixth aspect, an embodiment of this application provides a computer program product, where the program product is stored in a storage medium, and the program product is executed by at least one processor to implement the steps of the control display method in the first aspect.

In the control display method provided in the embodiment of this application, in a case that a target interface is displayed on a display screen of an in-vehicle electronic device, where the target interface is a projection interface of a mobile electronic device on the display screen, the electronic device receives and responds to a first input inputted by a user and used to adjust a focus position, moves the focus position to a target control, and displays the target control in a target display manner. The target control is a control in the target interface, the target display manner is consistent with a display manner of a focus state control in a first interface of the in-vehicle electronic device, and the first interface is a native interface of the in-vehicle electronic device.

According to the control display method, in the case that the display screen of the in-vehicle electronic device displays the projection interface of the mobile electronic device thereon, namely, the target interface, the in-vehicle electronic device displays the target control in the focus position in a display manner (namely, the target display manner) of the focus state control in the native interface thereof in response to the first input from the user used to move the focus position to the target control. In this way, when the mobile electronic device performs screen projection to the in-vehicle electronic device, a display style of interface content in the native interface of the in-vehicle electronic device itself is consistent with that of interface content in the projection interface, thereby ensuring style uniformity and aesthetic of overall display content of the in-vehicle electronic device, and ensuring naturalness of a screen projection effect.

### BRIEF DESCRIPTION OF DRAWINGS

FIG. 1 is a schematic flowchart of a control display method according to an embodiment of this application;

FIG. 2 is a first schematic diagram of display of a focus state control according to an embodiment of this application;

FIG. 3 is a second schematic diagram of display of a focus state control according to an embodiment of this application;

FIG. 4 is a third schematic diagram of display of a focus state control according to an embodiment of this application;

FIG. 5 is a fourth schematic diagram of display of a focus state control according to an embodiment of this application;

FIG. 6 is a structural block diagram of a control display apparatus according to an embodiment of this application;

FIG. 7 is a structural block diagram of an electronic device according to an embodiment of this application; and

FIG. 8 is a schematic diagram of a hardware structure of an electronic device according to an embodiment of this application.

### DETAILED DESCRIPTION

The following clearly describes the technical solutions in the embodiments of this application with reference to the accompanying drawings in the embodiments of this application. Clearly, the described embodiments are some but not all of the embodiments of this application. All other embodiments obtained by a person of ordinary skill in the art based on the embodiments of this application shall fall within the protection scope of this application.

In the specification and claims of this application, the terms “first” and “second” are used to distinguish between similar objects, but are not used to describe a specific sequence or order. It should be understood that terms used in such a way are exchangeable in a proper case, so that the embodiments of this application described herein can be implemented in an order other than the order shown or described herein. In addition, objects distinguished by “first”, “second”, and the like are generally of one type, and a quantity of objects is not limited. For example, there may be one or more first objects. In addition, “and/or” in this specification and the claims represents at least one of the connected objects, and the character “/” generally represents an “or” relationship between the associated objects.

An embodiment of a first aspect of this application provides a control display method. An execution body of the technical solution of the control display method provided in this embodiment of this application may be a control display apparatus, and may be determined according to an actual use needs, which is not limited in embodiments of this application. To describe the control display method provided in the embodiments of this application more clearly, in the following method embodiments, the execution body of the control display method being a control display apparatus is used as an example for description.

With reference to the accompanying drawings, the following describes, by using a specific embodiment and an application scenario thereof, in detail the control display method provided in embodiments of this application.

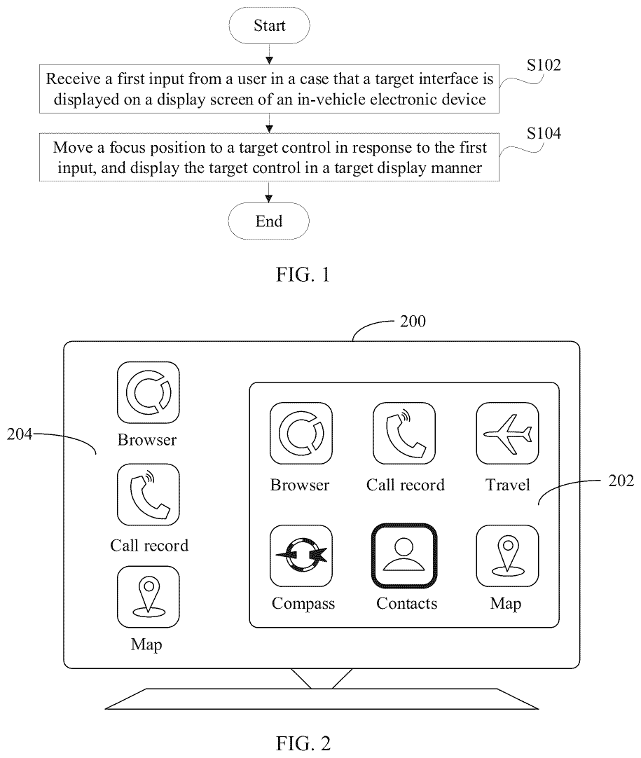

As shown in FIG. 1, an embodiment of this application provides a control display method. The method may include the following S102 and S104:

S102: Receive a first input from a user in a case that a target interface is displayed on a display screen of an in-vehicle electronic device.

The control display method provided in this embodiment of this application is performed by the in-vehicle electronic device, and the in-vehicle electronic device can receive a screen projection request of another mobile electronic device. In an actual application process, the in-vehicle electronic device may be a display device such as an in-vehicle screen or an in-vehicle computer, which is not specifically limited herein.

Further, the target interface is a projection interface of a mobile electronic device on the display screen of the in-vehicle electronic device, that is, the target interface is used to display interface content of the mobile electronic device.

The mobile electronic device is an electronic device that can send a screen projection request to the in-vehicle electronic device. In an actual application process, the mobile electronic device may be an electronic device such as a smartphone, a laptop computer, a tablet computer, and an intelligent wearable device that have a function of initiating screen projection, which is not specifically limited herein.

Further, in an actual application process, the target interface may be fully displayed on the display screen of the in-vehicle electronic device, and the target interface may be displayed in a form of a small window in a partial region of the display screen of the in-vehicle electronic device, which is not specifically limited herein.

Further, the first input is used to adjust a focus position to trigger a target focus event.

It may be understood that a focus event is an event triggered when a control loses a focus or obtains a focus. In a computer programming language, a focus refers to a position in which a current cursor is activated, that is, which control in an interface is selected, and which control can be operated. For example, a text box obtains a focus, and a character entered by a user on a keyboard directly enters the text box. A drop-down list obtains a focus, and a down arrow on the keyboard is clicked to display the list. The focus event may include three focus events DOMFocusIn, focus, and focusin that are triggered when a control obtains a focus, and three focus events blur, DOMFocusInOut, and focusout that are triggered when a control loses a focus.

On this basis, the first input may be an input by the user to move a cursor on the display screen of the in-vehicle electronic device to a target control in the target interface, so that the target control in the target interface obtains a focus through the first input. That is, the target focus event is a focus event triggered when the target control in the target interface obtains the focus. The target control may be a control such as an operation control, a text input box, and an application icon in the target interface, and is not specifically limited herein.

In an actual application process, after the mobile electronic device performs screen projection to the in-vehicle electronic device to display the target interface on the display screen of the in-vehicle electronic device, the user may operate and control, by using an operation and control apparatus such as a remote control apparatus and a knob corresponding to the in-vehicle electronic device, the cursor on the display screen of the in-vehicle electronic device to move, so that the cursor moves to the target control in the target interface, and the target control obtains the focus to trigger the target focus event.

S104: Move a focus position to a target control in response to the first input, and display the target control in a target display manner.

The target control is a control in the target interface, the target display manner is consistent with a display manner of a focus state control in a first interface of the in-vehicle electronic device, and the first interface is a native interface of the in-vehicle electronic device.

It may be understood that, in an interface design field, for each control in an interface, a focus state control is a control that obtains a focus, that is, a focus state is a selected state of a control in the interface, so as to help the user perceive that the control is touched.

However, in an actual application process, because manners of displaying the focus state control by the mobile electronic device and the in-vehicle electronic device are different, after the mobile electronic device performs screen projection to the in-vehicle electronic device, the display manner of the focus state control in the native interface of the in-vehicle electronic device is different from a display manner of a focus state control in the projection interface. For example, as shown in FIG. 2, a target interface 202 and a first interface 204 are displayed on a display screen of an in-vehicle electronic device 200, where the target interface 202 is a projection interface of a mobile electronic device in the in-vehicle electronic device 200, and the first interface 204 is a native interface of the in-vehicle electronic device 200 itself. Further, as shown in FIG. 2, a display manner of a focus state control in the first interface 204 is: adding a gray background to a control icon, and a display manner of a focus state control in the target interface 202 is: thickening a border line of a control icon. In this way, an overall display style of display content on the display screen of the in-vehicle electronic device is not uniform, and a screen projection effect is not natural enough.

Therefore, in the control display method provided in this embodiment of this application, after the mobile electronic device performs screen projection to the in-vehicle electronic device to display the target interface on the display screen of the in-vehicle electronic device, when the user operates and controls the cursor of the in-vehicle electronic device to move to the target control in the target interface, so as to trigger the target focus event, the in-vehicle electronic device moves the focus position to the target control in response to the input from the user, and displays the target control in the target display manner, that is, displays the target control in the display manner of the focus state control in the native interface of the in-vehicle electronic device.

That is, in the control display method provided in this embodiment of this application, in a process in which screen projection is performed to the in-vehicle electronic device, the in-vehicle electronic device displays the target control in the projection interface according to a focus state display parameter of the in-vehicle electronic device itself, so that the display style of the focus state control in the native interface of the in-vehicle electronic device itself is consistent with the display style of the focus state control in the projection interface, thereby ensuring uniformity of content display styles of the in-vehicle electronic device.

The focus state display parameter of the in-vehicle electronic device is a display parameter of the focus state control in the native interface of the in-vehicle electronic device itself. Specific parameter information of the focus state display parameter is set, so that a corresponding display state is presented after a control in an interface is selected, that is, a corresponding focus state is assigned to the control in the interface. For example, the specific parameter information of the focus state display parameter of the in-vehicle electronic device is set, so that after a control in the display interface of the in-vehicle electronic device is selected, the control is displayed in a form of adding a shadow to the control, or the control is magnified and displayed.

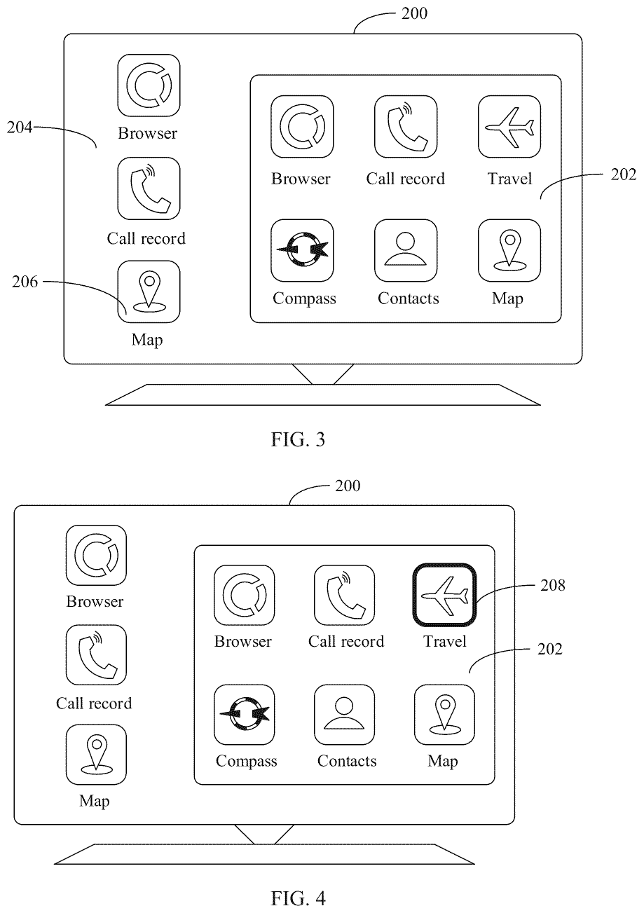

For example, as shown in FIG. 3, a target interface 202 and a first interface 204 are displayed on a display screen of an in-vehicle electronic device 200. The target interface 202 is a projection interface of a mobile electronic device in the in-vehicle electronic device 200, and the target interface 202 is configured to display interface content of the mobile electronic device. The first interface 204 is a native interface of the in-vehicle electronic device 200 itself, and a first focus state control 206 is displayed in the first interface. The first focus state control 206 is a display state of an application icon of a first application after the first application “Map” in the native interface of the in-vehicle electronic device 200 itself is selected. As shown in FIG. 3, the first focus state control 206 is obtained by adding a gray background to the application icon of the first application, that is, a focus state control in the native interface of the in-vehicle electronic device 200 is displayed in a display form of adding a gray background.

Further, as shown in FIG. 4, a second focus state control 208 is displayed in the target interface 202, and the second focus state control 208 is a display state of an application icon of a second application after the second application “Travel” of the mobile electronic device in the projection interface of the in-vehicle electronic device 200 is selected. It should be noted that a display style of the second focus state control 208 is consistent with the display style of the focus state control in a native interface of the mobile electronic device itself. In some embodiments, as shown in FIG. 4, the second focus state control 208 is obtained by thickening a border of the application icon of the second application, that is, the focus state control in the native interface of the mobile electronic device itself is represented in a display form of a thickened border.

It may be learned from the foregoing figure that the display style of the focus state control in the projection interface (namely, the target interface 202) of the in-vehicle electronic device 200 is relatively different from the display style of the focus state control in the native interface (namely, the first interface 204) of the in-vehicle electronic device 200.

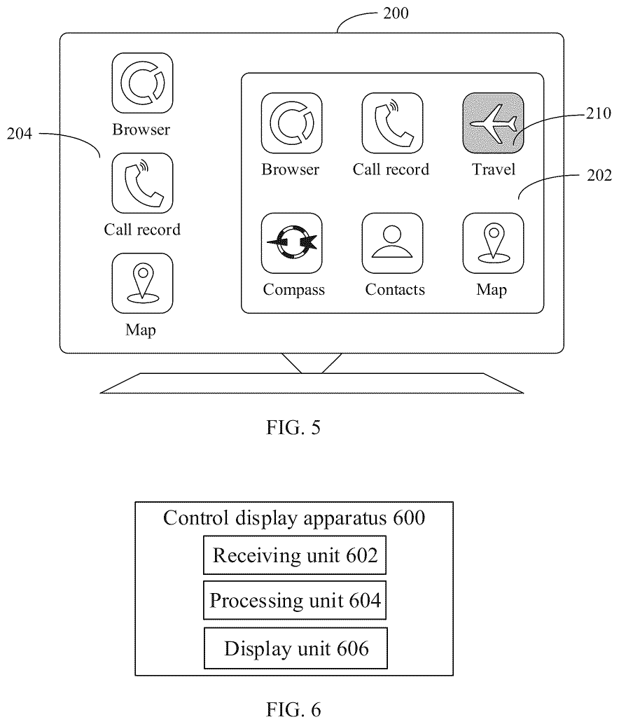

On this basis, by using the control display method provided in the embodiment of this application, after the display manner of the focus state control in the projection interface (namely, the target interface) of the in-vehicle electronic device is adjusted, as shown in FIG. 5, a third focus state control 210 is displayed in the target interface 202, and the third focus state control 210 is a display state of the application icon of the second application after the second application “Travel” of the mobile electronic device in the projection interface of the in-vehicle electronic device 200 is selected. As shown in FIG. 5, the third focus state control 210 is obtained by adding a gray background to the application icon of the second application. In this way, the display style of the focus state control in the projection interface of the in-vehicle electronic device 200 is consistent with the display style of the focus state control in the native interface of the in-vehicle electronic device 200 itself, thereby ensuring style uniformity of overall display content of the in-vehicle electronic device.

According to the control display method, in a process of displaying interface content of the mobile electronic device by performing screen projection to the in-vehicle electronic device, in the case that the display screen of the in-vehicle electronic device displays the projection interface of the mobile electronic device thereon, the in-vehicle electronic device displays the target control in the focus position in a display manner (namely, the target display manner) of the focus state control in the native interface thereof in response to the first input from the user used to move the focus position to the target control. In this way, when the mobile electronic device performs screen projection to the in-vehicle electronic device, the display style of interface content in the native interface of the in-vehicle electronic device itself can be made consistent with that of interface content in the projection interface, thereby ensuring style uniformity and aesthetic of overall display content of the in-vehicle electronic device.

In addition, it should be noted that, in an actual application process, the control display method provided in the embodiment of this application is not limited to being performed by an in-vehicle electronic device, and the control display method may be further performed by a display device such as a smart television, a desktop computer, a laptop computer, and a tablet computer that have a function of receiving screen projection, which is not specifically limited herein.

In an embodiment of this application, the step of displaying the target control in the target display manner may include the following S106:

S106: Send a focus state display parameter of the in-vehicle electronic device and a control name of the target control to the mobile electronic device, so that the mobile electronic device adjusts a display manner of the target control in a second interface to the target display manner according to the focus state display parameter.

The second interface is a display interface of the mobile electronic device, and display content of the second interface is the same as that of the target interface.

In the control display method provided in embodiments of this application, after the mobile electronic device performs screen projection to the in-vehicle electronic device to display the target interface on the display screen of the in-vehicle electronic device, when the user controls the cursor of the in-vehicle electronic device to move to the target control in the target interface, in response to the operation of the user, after determining the target control, the in-vehicle electronic device sends the focus state display parameter thereof and the control name of the target control to the mobile electronic device through a data channel established when the mobile electronic device performs screen projection to the in-vehicle electronic device, so that the mobile electronic device adjusts the display manner of the target control in the second interface thereof to the target display manner according to the focus state display parameter of the in-vehicle electronic device. That is, the mobile electronic device redraws a focus state style of the target control in the display interface thereof according to the focus state display parameter of the in-vehicle electronic device, so that a focus state display style of the target control in the display interface thereof is consistent with a focus state display style in the native interface of the in-vehicle electronic device itself.

On this basis, the mobile electronic device then performs screen projection to the interface of the in-vehicle electronic device. Because the focus state style of the target control has been redrawn, both the interface of the mobile electronic device and the projection interface of the in-vehicle electronic device display the target control in the target display manner.

In the foregoing embodiment provided in this application, after the in-vehicle electronic device receives the first input from the user to move the focus position to the target control, the in-vehicle electronic device sends the focus state display parameter thereof and the control name of the target control to the mobile electronic device, so that the mobile electronic device adjusts the display manner of the target control in the display interface thereof to the target display manner according to the received focus state display parameter. In this way, the in-vehicle electronic device sends the focus state display parameter thereof to the mobile electronic device, so that the mobile electronic device adjusts, according to the focus state display parameter, the display manner of the target control in the display interface thereof to the target display manner, so that the display manner of the target control in the projection interface of the in-vehicle electronic device is automatically updated to the target display manner, thereby ensuring style uniformity and aesthetic of display content of the in-vehicle electronic device, and ensuring naturalness of a screen projection effect.

In an embodiment of this application, the step of displaying the target control in the target display manner may include the following S108 to S112:

S108: Send a control name of the target control to the mobile electronic device, so that the mobile electronic device feeds back target control information of the target control to the in-vehicle electronic device.

In the control display method provided in embodiments of this application, after the mobile electronic device performs screen projection to the in-vehicle electronic device to display the target interface on the display screen of the in-vehicle electronic device, when the user controls the cursor of the in-vehicle electronic device to move to the target control in the target interface, in response to the input from the user, the in-vehicle electronic device sends the control name of the target control to the mobile electronic device through a data channel established when the mobile electronic device performs screen projection thereto, so that the mobile electronic device feeds back the target control information of the target control to the in-vehicle electronic device.

S110: Receive the target control information fed back by the mobile electronic device.

The target control information may include information such as a target control icon, a target control position, and a target control size.

In some embodiments, after the in-vehicle electronic device sends the control name of the target control to the mobile electronic device, the mobile electronic device determines, according to the received control name, the target control corresponding to the control name in the display interface thereof. Further, the mobile electronic device sends the target control information of the target control to the in-vehicle electronic device through the data channel established when the mobile electronic device performs screen projection to the in-vehicle electronic device. On this basis, the in-vehicle electronic device receives the target control information fed back by the mobile electronic device, so as to prepare for subsequently drawing and displaying the focus state style of the target control in the target interface thereof according to the target control information.

S112: Draw a first control according to the target control information and the focus state display parameter of the in-vehicle electronic device, and display the first control in a target position.

The target position is corresponding to a display position of the target control in the target interface, and the first control is the target control displayed in the target display manner, that is, the first control has the focus state display style of the target control.

In some embodiments, after receiving the target control information, the in-vehicle electronic device redraws the focus state display style of the target control according to the target control information and the focus state display parameter thereof, that is, draws the first control, and displays the drawn first control in the target position according to control information of the target control.

It can be understood that, the in-vehicle electronic device makes the drawn first control overlaid in an original position of the target control in the target interface.

It can be understood that the display style of the redrawn first control is consistent with the display style of the focus state control in the native interface of the in-vehicle electronic device itself.

In the foregoing embodiment provided in this application, after the in-vehicle electronic device receives the first input from the user to move the focus position to the target control, the in-vehicle electronic device sends the control name of the target control to the mobile electronic device, so that the mobile electronic device feeds back the target control information of the target control to the in-vehicle electronic device. On this basis, the in-vehicle electronic device receives the target control information fed back by the mobile electronic device, draws the first control according to the target control information and the focus state display parameter thereof, and displays the first control in the target position. In this way, the in-vehicle electronic device draws, according to the focus state display parameter thereof and the control information of the target control, the first control whose display style is consistent with the display style of the focus state control in the native interface thereof, and makes the first control overlaid in the original position of the target control in the target interface, so that the display style of interface content in the native interface of the in-vehicle electronic device itself is consistent with that of interface content in the projection interface, thereby ensuring style uniformity and aesthetic of display content of the in-vehicle electronic device.

In an embodiment of this application, the target control information includes a target control icon, a target control position, and a target control size. On this basis, S112 may include the following S112a to S112c:

S112a: Process the target control icon according to the focus state display parameter, to obtain a second control.

In this embodiment, the target control information may include a target control icon, a target control position, and a target control size.

In an actual application process, the target control may be a control such as an operation control, a text input box, and an application icon in the target interface. On this basis, the target control icon may be a display image of the operation control in the target interface, a display image of the text input box in the target interface, an image of the application icon, or the like, which is not specifically limited herein.

Further, the target control position may be position information of the target control icon in the target interface, and the position information may include information such as a position coordinate range in the target interface, and a distance between a boundary of the target control icon and a boundary of the target interface.

Further, the target control size may be a display size of the target control icon in the target interface.

In the control display method provided in embodiments of this application, after the in-vehicle electronic device receives the target control information, the in-vehicle electronic device processes the target control icon of the target control according to the focus state display style indicated by the focus state display parameter thereof, so as to obtain the second control whose display style is consistent with the display style of the focus state control in the native interface of the in-vehicle electronic device itself.

For example, in a case that the focus state display style indicated by the focus state display parameter of the in-vehicle electronic device is that a border is thickened for display, the in-vehicle electronic device performs thickening processing on a boundary line of the target control icon. In a case that the focus state display style indicated by the focus state display parameter of the in-vehicle electronic device is that a border is highlighted for display, the in-vehicle electronic device performs highlight processing on the boundary line of the target control icon, that is, displays the boundary line of the target control icon in a relatively bright color. In a case that the focus state display style indicated by the focus state display parameter of the in-vehicle electronic device is dark background display, the in-vehicle electronic device adjusts a background color of the target control icon to a dark color such as gray. In a case that the focus state display style indicated by the focus state display parameter of the in-vehicle electronic device is magnified display, the in-vehicle electronic device performs magnification processing on the target control icon. In a case that the focus state display style indicated by the focus state display parameter of the in-vehicle electronic device is shadow effect display, the in-vehicle electronic device adds a shadow effect to the target control icon.

S112b: Adjust a size of the second control according to the target control size to obtain the first control.

The target control size is the display size of the target control icon in the target interface.

In some embodiments, after the in-vehicle electronic device processes the target control icon according to the focus state display style indicated by the focus state display parameter thereof, so as to obtain the second control, the in-vehicle electronic device adjusts the size of the second control according to the display size of the target control icon in the target interface, so that the size of the second control corresponds to the display size of the target control icon in the target interface.

S112c: Display the first control in the target position.

In some embodiments, the target position is the display position of the target control icon in the target interface.

According to the foregoing embodiment provided in this application, the target control information includes the target control icon, the target control position, and the target control size. On this basis, after the in-vehicle electronic device receives the target control information fed back by the mobile electronic device, the in-vehicle electronic device processes the target control icon according to the focus state display parameter thereof to obtain the second control, further adjusts the size of the second control according to the target control size to obtain the first control, and displays the first control in the target position, in the target interface, corresponding to the target control position. In this way, the in-vehicle electronic device draws, according to the focus state display parameter thereof and the control information of the target control, the first control whose display style is consistent with the display style of the focus state control in the native interface thereof, and makes the first control overlaid in the original position of the target control in the target interface, so that the display style of interface content in the native interface of the in-vehicle electronic device itself is consistent with that of interface content in the projection interface, thereby ensuring style uniformity and aesthetic of display content of the in-vehicle electronic device.

In an embodiment of this application, the focus state display parameter includes at least one of the following: a border display parameter, a zoom parameter, a background display parameter, a shadow display parameter, a brightness display parameter, and a color display parameter.

In this embodiment, the focus state display parameter of the in-vehicle electronic device may include the border display parameter used to indicate a control border display form, the zoom parameter used to indicate a control display size, the background display parameter used to indicate a control background display form, the shadow display parameter used to indicate a control shadow display form, the brightness display parameter used to indicate control display brightness, and the color display parameter used to indicate a control display color.

The border display parameter may include parameter information such as a shape of a border line, for example, a dotted line or a solid line, a color of the border line, and a thickness of the border line. The zoom parameter may include a zoom ratio of the target control icon. The background display parameter may include parameter information such as a background color and a background image such as a stripe background. The shadow display parameter may include parameter information such as a shadow color, a shadow direction, and a shadow shape. The brightness display parameter may include parameter information such as a control highlighted region and a brightness value. The color display parameter may include a display color of the target control icon.

For example, the target control is a target application icon in the target interface. On this basis, in a case that the control border display form indicated by the border display parameter in the focus state display parameter is a blue dotted-line thickened border, after the target application icon is selected, a border of the target application icon is displayed as a blue dotted line, and a border line of the target application icon is thickened.

Further, in a case that the control display size indicated by the zoom parameter in the focus state display parameter is N times of an initial display size of a control, after the target application icon is selected, the display size of the target application icon is magnified N times and then displayed.

Further, in a case that the control background display form indicated by the background display parameter in the focus state display parameter is a striped red background, after the target application icon is selected, a background of the target application icon is displayed as a red striped image.

Further, in a case that the control shadow display form indicated by the shadow display parameter in the focus state display parameter is an oval shadow effect tilted to the upper right, after the target application icon is selected, an oval shadow tilted to the upper right is added to the target application icon for display.

Further, in a case that the control display brightness indicated by the brightness display parameter in the focus state display parameter is a control border being highlighted in red, after the target application icon is selected, the border of the target application icon is displayed in red, and the border of the target application icon presents a luminous display effect.

Further, in a case that the control display color indicated by the color display parameter in the focus state display parameter is green, after the target application icon is selected, the border of the target application icon and a specific pattern of the icon are displayed in green.

In the foregoing embodiment provided in this application, the focus state display parameter includes at least one of the following: a border display parameter, a zoom parameter, a background display parameter, a shadow display parameter, a brightness display parameter, and a color display parameter. In this way, in a process in which screen projection is performed to the in-vehicle electronic device, the in-vehicle electronic device displays the focus state control of the target control in the focus state display form indicated by the focus state display parameter of the native interface thereof, so that the display style of the focus state control in the native interface of the in-vehicle electronic device itself is consistent with the display style of the focus state control in the projection interface, thereby ensuring style uniformity and aesthetic of display content of the in-vehicle electronic device.

An execution body of the control display method provided in the embodiment of the first aspect of this application may be a control display apparatus. In an embodiment of this application, that the control display apparatus performs the foregoing control display method is used as an example to describe the control display apparatus provided in a second aspect of this application.

As shown in FIG. 6, an embodiment of this application provides a control display apparatus 600. The apparatus is applied to an in-vehicle electronic device, and the control display apparatus 600 may include the following receiving unit 602, processing unit 604, and display unit 606.

The receiving unit 602 is configured to: receive a first input from a user in a case that a target interface is displayed on a display screen of the in-vehicle electronic device, where the target interface is a projection interface of a mobile electronic device on the display screen, and the first input is used to adjust a focus position;
the processing unit 604 is configured to: move the focus position to a target control in response to the first input; and
the display unit 606 is configured to display the target control in a target display manner, where the target control is a control in the target interface, the target display manner is consistent with a display manner of a focus state control in a first interface of the in-vehicle electronic device, and the first interface is a native interface of the in-vehicle electronic device.

According to the control display apparatus provided in the embodiment of this application, in a case that a target interface is displayed on a display screen of an in-vehicle electronic device, where the target interface is a projection interface of a mobile electronic device on the display screen, the electronic device receives and responds to a first input inputted by a user and used to adjust a focus position, moves the focus position to a target control in the target interface, and displays the target control in a target display manner. The target display manner is consistent with a display manner of a focus state control in a first interface of the in-vehicle electronic device, and the first interface is a native interface of the in-vehicle electronic device. In this way, when the mobile electronic device performs screen projection to the in-vehicle electronic device, the target control in the focus position in the projection interface is displayed in the display manner of the focus state control in the native interface of the in-vehicle electronic device, so that the display style of interface content in the native interface of the in-vehicle electronic device itself is consistent with that of interface content in the projection interface, thereby ensuring style uniformity and aesthetic of overall display content of the in-vehicle electronic device.

In this embodiment of this application, the processing unit 604 is further configured to send a focus state display parameter of the in-vehicle electronic device and a control name of the target control to the mobile electronic device, so that the mobile electronic device adjusts a display manner of the target control in a second interface to the target display manner according to the focus state display parameter, where the second interface is a display interface of the mobile electronic device, and display content of the second interface is the same as that of the target interface.

In the foregoing embodiment provided in this application, after the in-vehicle electronic device receives the first input from the user to move the focus position to the target control, the in-vehicle electronic device sends the focus state display parameter thereof and the control name of the target control to the mobile electronic device, so that the mobile electronic device adjusts the display manner of the target control in the display interface thereof to the target display manner according to the received focus state display parameter. In this way, the in-vehicle electronic device sends the focus state display parameter thereof to the mobile electronic device, so that the mobile electronic device adjusts the display manner of the target control in the display interface thereof to the target display manner, so that the display manner of the target control in the projection interface of the in-vehicle electronic device is automatically updated to the target display manner, thereby ensuring style uniformity and aesthetic of display content of the in-vehicle electronic device, and ensuring naturalness of a screen projection effect.

In this embodiment of this application, the processing unit 604 is further configured to send a control name of the target control to the mobile electronic device, so that the mobile electronic device feeds back target control information of the target control to the in-vehicle electronic device; receive the target control information fed back by the mobile electronic device; and draw a first control according to the target control information and a focus state display parameter of the in-vehicle electronic device. The display unit 606 is configured to display the first control in a target position, where the target position corresponds to a display position of the target control in the target interface, and the first control is the target control displayed in the target display manner.

In this embodiment of this application, the target control information includes a target control icon, a target control position, and a target control size, and the processing unit 604 is configured to: process the target control icon according to the focus state display parameter, to obtain a second control; and adjust a size of the second control according to the target control size to obtain the first control. The display unit 606 is configured to display the first control in the target position.

In this embodiment of this application, the focus state display parameter includes at least one of the following: a border display parameter, a zoom parameter, a background display parameter, a shadow display parameter, a brightness display parameter, and a color display parameter.

The control display apparatus 600 in this embodiment of this application may be an electronic device, or may be a component in the electronic device, such as an integrated circuit or a chip. The electronic device may be a terminal, or may be another device different from the terminal. For example, the electronic device may be a mobile phone, a tablet computer, a notebook computer, a palmtop computer, an in-vehicle electronic device, a mobile Internet device (MID), an augmented reality (AR)/virtual reality (VR) device, a robot, a wearable device, a ultra-mobile personal computer (UMPC), a netbook or a personal digital assistant (PDA), or the like, or may be a server, a network attached storage (NAS), a personal computer (PC), a television (TV), a teller machine, or an automated machine. This is not specifically limited in embodiments of this application.

The control display apparatus 600 in this embodiment of this application may be an apparatus with an operating system. The operating system may be an Android operating system, may be an iOS operating system, or may be another possible operating system. This is not specifically limited in embodiments of this application.

The control display apparatus 600 provided in the embodiment of the second aspect of this application can implement processes implemented in the method embodiment of FIG. 1. To avoid repetition, details are not described herein again.

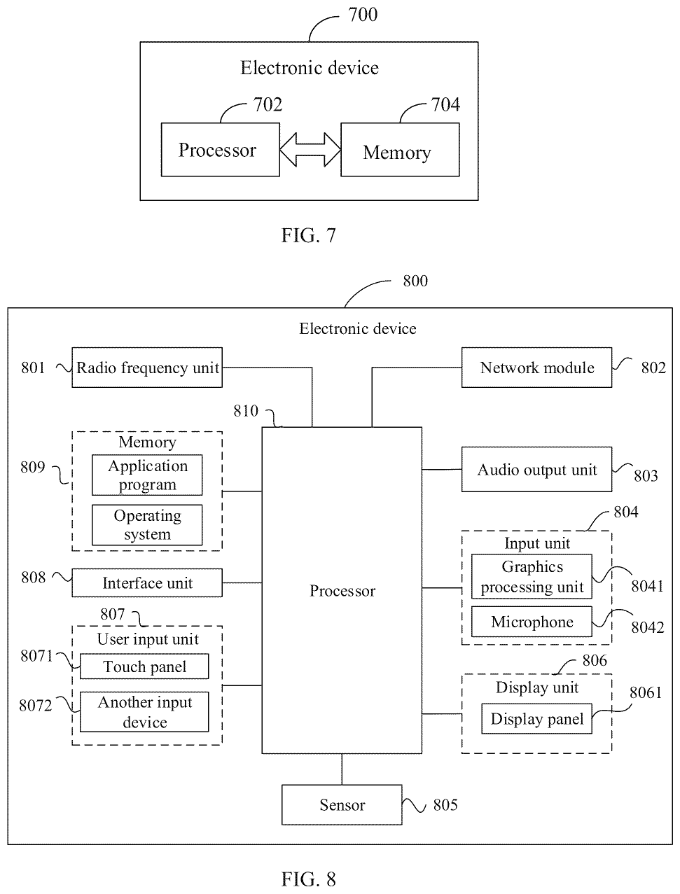

As shown in FIG. 7, an embodiment of this application further provides an electronic device 700, including a processor 702 and a memory 704. The memory 704 stores a program or instructions capable of running on the processor 702. The program or the instructions are executed by the processor 702 to implement the steps in the control display method embodiment of the first aspect, and a same technical effect can be achieved. To avoid repetition, details are not described herein again.

It should be noted that the electronic device in this embodiment of this application includes the foregoing mobile electronic device and non-mobile electronic device.

FIG. 8 is a schematic diagram of a hardware structure of an electronic device that implements an embodiment of this application.

The electronic device 800 includes but is not limited to components such as a radio frequency unit 801, a network module 802, an audio output unit 803, an input unit 804, a sensor 805, a display unit 806, a user input unit 807, an interface unit 808, a memory 809, and a processor 810.

A person skilled in the art may understand that the electronic device 800 may further include a power supply (for example, a battery) that supplies power to each component. The power supply may be logically connected to the processor 810 by using a power management system, to manage functions such as charging, discharging, and power consumption by using the power management system. The structure of the electronic device shown in FIG. 8 constitutes no limitation on the electronic device, and the electronic device may include more or fewer components than those shown in the figure, or combine some components, or have different component arrangements. Details are not described herein again.

The electronic device 800 in this embodiment of this application may be configured to implement the steps in the control display method embodiment of the first aspect.

The user input unit 807 is configured to: receive a first input from a user in a case that a target interface is displayed on a display screen of an in-vehicle electronic device, where the target interface is a projection interface of a mobile electronic device on the display screen, and the first input is used to adjust a focus position.

The processor 810 is configured to: move the focus position to a target control in response to the first input.

The display unit 806 is configured to display the target control in a target display manner, where the target control is a control in the target interface, the target display manner is consistent with a display manner of a focus state control in a first interface of the in-vehicle electronic device, and the first interface is a native interface of the in-vehicle electronic device.

In this embodiment of this application, in a case that a target interface is displayed on a display screen of an in-vehicle electronic device, where the target interface is a projection interface of a mobile electronic device on the display screen, the electronic device receives and responds to a first input inputted by a user and used to adjust a focus position, moves the focus position to a target control in the target interface, and displays the target control in a target display manner. The target display manner is consistent with a display manner of a focus state control in a first interface of the in-vehicle electronic device, and the first interface is a native interface of the in-vehicle electronic device. That is, in a process of displaying interface content of the mobile electronic device by performing screen projection to the in-vehicle electronic device, in the case that the display screen of the in-vehicle electronic device displays the projection interface of the mobile electronic device thereon, namely, the target interface, the in-vehicle electronic device displays the target control in the focus position in a display manner (namely, the target display manner) of the focus state control in the native interface thereof in response to the first input from the user used to move the focus position to the target control. In this way, when the mobile electronic device performs screen projection to the in-vehicle electronic device, the target control in the focus position in the projection interface is displayed in the display manner of the focus state control in the native interface of the in-vehicle electronic device, so that the display style of interface content in the native interface of the in-vehicle electronic device itself is consistent with that of interface content in the projection interface, thereby ensuring style uniformity and aesthetic of overall display content of the in-vehicle electronic device.

In some embodiments, the processor 810 is further configured to send a focus state display parameter of the in-vehicle electronic device and a control name of the target control to the mobile electronic device, so that the mobile electronic device adjusts a display manner of the target control in a second interface to the target display manner according to the focus state display parameter, where the second interface is a display interface of the mobile electronic device, and display content of the second interface is the same as that of the target interface.

In the foregoing embodiment provided in this application, after the in-vehicle electronic device receives the first input from the user to move the focus position to the target control, the in-vehicle electronic device sends the focus state display parameter thereof and the control name of the target control to the mobile electronic device, so that the mobile electronic device adjusts the display manner of the target control in the display interface thereof to the target display manner according to the received focus state display parameter. In this way, the in-vehicle electronic device sends the focus state display parameter thereof to the mobile electronic device, so that the mobile electronic device adjusts the display manner of the target control in the display interface thereof to the target display manner, so that the display manner of the target control in the projection interface of the in-vehicle electronic device is automatically updated to the target display manner, thereby ensuring style uniformity and aesthetic of display content of the in-vehicle electronic device.

In some embodiments, the processor 810 is further configured to send a control name of the target control to the mobile electronic device, so that the mobile electronic device feeds back target control information of the target control to the in-vehicle electronic device; receive the target control information fed back by the mobile electronic device; and draw a first control according to the target control information and a focus state display parameter of the in-vehicle electronic device. The display unit 806 is configured to display the first control in a target position, where the target position corresponds to a display position of the target control in the target interface, and the first control is the target control displayed in the target display manner.

In the foregoing embodiment provided in this application, after the in-vehicle electronic device receives the first input from the user to move the focus position to the target control, the in-vehicle electronic device sends the control name of the target control to the mobile electronic device, so that the mobile electronic device feeds back control information, namely, the target control information of the target control to the in-vehicle electronic device. On this basis, the in-vehicle electronic device receives the target control information fed back by the mobile electronic device, draws the first control according to the target control information and the focus state display parameter thereof, and displays the first control in the target position corresponding to the display position of the target control in the target interface. In this way, the in-vehicle electronic device draws, according to the focus state display parameter thereof and the control information of the target control, the first control whose display style is consistent with the display style of the focus state control in the native interface thereof, and makes the first control overlaid in the original position of the target control in the target interface, so that the display style of interface content in the native interface of the in-vehicle electronic device itself is consistent with that of interface content in the projection interface, thereby ensuring style uniformity and aesthetic of display content of the in-vehicle electronic device, and ensuring naturalness of a screen projection effect.

In some embodiments, the target control information includes a target control icon, a target control position, and a target control size, and the processor 810 is configured to: process the target control icon according to the focus state display parameter, to obtain a second control; and adjust a size of the second control according to the target control size to obtain the first control. The display unit 806 is configured to display the first control in the target position.

According to the foregoing embodiment provided in this application, the target control information includes the target control icon, the target control position, and the target control size. On this basis, the in-vehicle electronic device processes the target control icon according to the focus state display parameter to obtain the second control, further adjusts the size of the second control according to the target control size to obtain the first control, and displays the first control in the target position, in the target interface, corresponding to the target control position. In this way, the in-vehicle electronic device draws, according to the focus state display parameter thereof and the control information of the target control, the first control whose display style is consistent with the display style of the focus state control in the native interface thereof, and makes the first control overlaid in the original position of the target control in the target interface, so that the display style of interface content in the native interface of the in-vehicle electronic device itself is consistent with that of interface content in the projection interface, thereby ensuring style uniformity and aesthetic of display content of the in-vehicle electronic device, and ensuring naturalness of a screen projection effect.

In some embodiments, the focus state display parameter includes at least one of the following: a border display parameter, a zoom parameter, a background display parameter, a shadow display parameter, a brightness display parameter, or a color display parameter.

In the foregoing embodiment provided in this application, the focus state display parameter includes at least one of the following: a border display parameter, a zoom parameter, a background display parameter, a shadow display parameter, a brightness display parameter, or a color display parameter. In this way, in a process in which screen projection is performed to the in-vehicle electronic device, the in-vehicle electronic device displays the focus state control of the target control in the focus state display form indicated by the focus state display parameter of the native interface thereof, so that the display style of the focus state control in the native interface of the in-vehicle electronic device itself is consistent with the display style of the focus state control in the projection interface, thereby ensuring style uniformity and aesthetic of display content of the in-vehicle electronic device, and ensuring naturalness of a screen projection effect.

It should be understood that, in this embodiment of this application, the input unit 804 may include a graphics processing unit (GPU) 8041 and a microphone 8042. The graphics processing unit 8041 processes image data of a still picture or a video obtained by an image capture apparatus (such as a camera) in a video capture mode or an image capture mode. The display unit 806 may include a display panel 8061. The display panel 8061 may be configured in a form such as a liquid crystal display or an organic light-emitting diode. The user input unit 807 may include at least one of a touch panel 8071 or another input device 8072. The touch panel 8071 is also referred to as a touchscreen. The touch panel 8071 may include two parts: a touch detection apparatus and a touch controller. The another input device 8072 may include but is not limited to a physical keyboard, a function key (such as a volume control key or an on/off key), a trackball, a mouse, and a joystick. Details are not described herein.

The memory 809 may be configured to store a software program and various data. The memory 809 may mainly include a first storage area for storing a program or instructions and a second storage area for storing data, where the first storage area may store an operating system, an application program or instructions (such as a sound playback function or an image playback function) required by at least one function, and the like. In addition, the memory 809 may include a volatile memory or a non-volatile memory, or the memory 809 may include both a volatile memory and a non-volatile memory. The non-volatile memory may be a read-only memory (ROM), a programmable read-only memory (PROM), an erasable programmable read-only memory (EPROM), an electrically erasable programmable read-only memory (EEPROM), or a flash memory, The volatile memory may be a random access memory (RAM), a static random access memory (SRAM), a dynamic random access memory (DRAM), a synchronous dynamic random access memory (SDRAM), a double data rate synchronous dynamic random access memory (DDRSDRAM), an enhanced synchronous dynamic random access memory (ESDRAM), a synchronous link dynamic random access memory (SLDRAM), and a direct rambus random access memory (DRRAM). The memory 809 in this embodiment of this application includes but is not limited to these and any other suitable type of memory.

The processor 810 may include one or more processing units. In some embodiments, the processor 810 integrates an application processor and a modem processor, where the application processor mainly processes operations related to an operating system, a user interface, an application program, and the like, and the modem processor mainly processes a wireless communication signal, such as a baseband processor. It may be understood that the modem processor may not be integrated into the processor 810.

An embodiment of this application further provides a readable storage medium. The storage medium may be volatile or non-volatile. The readable storage medium stores a program or instructions. The program or the instructions are executed by a processor to implement the processes in the control display method embodiment of the first aspect, and a same technical effect can be achieved. To avoid repetition, details are not described herein again.

The processor is a processor in the electronic device in the foregoing embodiment. The readable storage medium includes a computer-readable storage medium such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the control display method embodiment of the first aspect, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application provides a computer program product. The program product is stored in a storage medium. The program product is executed by at least one processor to implement the processes in the control display method embodiment of the first aspect, and a same technical effect can be achieved. To avoid repetition, details are not described herein again.

It should be noted that, the terms “include”, “comprise”, or any other variation thereof in this specification are intended to cover a non-exclusive inclusion, so that a process, method, article, or apparatus that includes a list of elements includes the elements, and also includes other elements that are not expressly listed, or further includes elements inherent to such a process, method, article, or apparatus. Without more limitations, elements defined by the sentence “including one” does not exclude that there are still other same elements in the process, method, article, or apparatus that includes the elements. In addition, it should be noted that the scope of the method and apparatus in the embodiments of this application is not limited to performing a function in a sequence shown or discussed, and may further include performing a function in a basically simultaneous manner or in a reverse sequence based on a related function. For example, the described method may be performed in an order different from the described order, and various steps may be added, omitted, or combined. In addition, features described with reference to some examples may be combined in other examples.

Based on the descriptions in the foregoing implementations, a person skilled in the art may clearly learn that the method in the foregoing embodiment may be implemented by software in addition to a necessary universal hardware platform or by hardware. In most circumstances, the former is a better implementation. Based on such an understanding, the technical solutions of this application essentially, or the part contributing to the prior art, may be presented in the form of a computer software product. The computer software product is stored in a storage medium (for example, a ROM/RAM, a magnetic disk, or an optical disc) including several instructions to enable a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing specific implementations. The foregoing specific implementations are merely examples, and are not restrictive. Under the enlightenment of this application, many forms may be further made by a person of ordinary skill in the art without departing from the objective of this application and the protection scope of the claims and shall fall within the protection scope of this application.

1. A control display method, performed by an in-vehicle electronic device, comprising:
receiving a first input from a user when a target interface is displayed on a display screen of the in-vehicle electronic device, wherein the target interface is a projection interface of a mobile electronic device on the display screen, and the first input is used to adjust a focus position; and
moving the focus position to a target control in response to the first input, and displaying the target control in a target display manner, wherein the target control is a control in the target interface, the target display manner is consistent with a display manner of a focus state control in a first interface of the in-vehicle electronic device, and the first interface is a native interface of the in-vehicle electronic device.

2. The control display method according to claim 1, wherein displaying the target control in the target display manner comprises:
sending a focus state display parameter of the in-vehicle electronic device and a control name of the target control to the mobile electronic device, so that the mobile electronic device adjusts a display manner of the target control in a second interface to the target display manner according to the focus state display parameter,
wherein the second interface is a display interface of the mobile electronic device, and display content of the second interface is the same as that of the target interface.

3. The control display method according to claim 1, wherein displaying the target control in the target display manner comprises:
sending a control name of the target control to the mobile electronic device, so that the mobile electronic device feeds back target control information of the target control to the in-vehicle electronic device;
receiving the target control information fed back by the mobile electronic device; and
drawing a first control according to the target control information and a focus state display parameter of the in-vehicle electronic device, and displaying the first control in a target position, wherein the target position corresponds to a display position of the target control in the target interface, and the first control is the target control displayed in the target display manner.

4. The control display method according to claim 3, wherein the target control information comprises a target control icon, a target control position, and a target control size, and drawing the first control according to the target control information and the focus state display parameter of the in-vehicle electronic device, and displaying the first control in the target position comprises:
processing the target control icon according to the focus state display parameter, to obtain a second control;
adjusting a size of the second control according to the target control size to obtain the first control; and
displaying the first control in the target position.

5. The control display method according to claim 2, wherein the focus state display parameter comprises at least one of the following:
a border display parameter, a zoom parameter, a background display parameter, a shadow display parameter, a brightness display parameter, or a color display parameter.

6. An in-vehicle electronic device, comprising a processor and a memory storing a program or an instruction that is capable of running on the processor, wherein the program or the instruction, when executed by the processor, causes the electronic device to perform:
receiving a first input from a user when a target interface is displayed on a display screen of the in-vehicle electronic device, wherein the target interface is a projection interface of a mobile electronic device on the display screen, and the first input is used to adjust a focus position; and
moving the focus position to a target control in response to the first input, and displaying the target control in a target display manner, wherein the target control is a control in the target interface, the target display manner is consistent with a display manner of a focus state control in a first interface of the in-vehicle electronic device, and the first interface is a native interface of the in-vehicle electronic device.

7. The in-vehicle electronic device according to claim 6, wherein displaying the target control in the target display manner comprises:
sending a focus state display parameter of the in-vehicle electronic device and a control name of the target control to the mobile electronic device, so that the mobile electronic device adjusts a display manner of the target control in a second interface to the target display manner according to the focus state display parameter,
wherein the second interface is a display interface of the mobile electronic device, and display content of the second interface is the same as that of the target interface.

8. The in-vehicle electronic device according to claim 6, wherein displaying the target control in the target display manner comprises:
sending a control name of the target control to the mobile electronic device, so that the mobile electronic device feeds back target control information of the target control to the in-vehicle electronic device;
receiving the target control information fed back by the mobile electronic device; and
drawing a first control according to the target control information and a focus state display parameter of the in-vehicle electronic device, and displaying the first control in a target position, wherein the target position corresponds to a display position of the target control in the target interface, and the first control is the target control displayed in the target display manner.

9. The in-vehicle electronic device according to claim 8, wherein the target control information comprises a target control icon, a target control position, and a target control size, and drawing the first control according to the target control information and the focus state display parameter of the in-vehicle electronic device, and displaying the first control in the target position comprises:
processing the target control icon according to the focus state display parameter, to obtain a second control;
adjusting a size of the second control according to the target control size to obtain the first control; and
displaying the first control in the target position.

10. The in-vehicle electronic device according to claim 7, wherein the focus state display parameter comprises at least one of the following:
a border display parameter, a zoom parameter, a background display parameter, a shadow display parameter, a brightness display parameter, or a color display parameter.

11. A non-transitory computer-readable storage medium storing a program or an instruction, wherein the program or the instruction, when executed by a processor, causes the processor to perform:
receiving a first input from a user when a target interface is displayed on a display screen of an in-vehicle electronic device, wherein the target interface is a projection interface of a mobile electronic device on the display screen, and the first input is used to adjust a focus position; and
moving the focus position to a target control in response to the first input, and displaying the target control in a target display manner, wherein the target control is a control in the target interface, the target display manner is consistent with a display manner of a focus state control in a first interface of the in-vehicle electronic device, and the first interface is a native interface of the in-vehicle electronic device.

12. The non-transitory computer-readable storage medium according to claim 11, wherein displaying the target control in the target display manner comprises:
sending a focus state display parameter of the in-vehicle electronic device and a control name of the target control to the mobile electronic device, so that the mobile electronic device adjusts a display manner of the target control in a second interface to the target display manner according to the focus state display parameter,
wherein the second interface is a display interface of the mobile electronic device, and display content of the second interface is the same as that of the target interface.

13. The non-transitory computer-readable storage medium according to claim 11, wherein displaying the target control in the target display manner comprises:
sending a control name of the target control to the mobile electronic device, so that the mobile electronic device feeds back target control information of the target control to the in-vehicle electronic device;
receiving the target control information fed back by the mobile electronic device; and
drawing a first control according to the target control information and a focus state display parameter of the in-vehicle electronic device, and displaying the first control in a target position, wherein the target position corresponds to a display position of the target control in the target interface, and the first control is the target control displayed in the target display manner.

14. The non-transitory computer-readable storage medium according to claim 13, wherein the target control information comprises a target control icon, a target control position, and a target control size, and drawing the first control according to the target control information and the focus state display parameter of the in-vehicle electronic device, and displaying the first control in the target position comprises:
processing the target control icon according to the focus state display parameter, to obtain a second control;
adjusting a size of the second control according to the target control size to obtain the first control; and
displaying the first control in the target position.

15. The non-transitory computer-readable storage medium according to claim 12, wherein the focus state display parameter comprises at least one of the following:
a border display parameter, a zoom parameter, a background display parameter, a shadow display parameter, a brightness display parameter, or a color display parameter.
